(19) United States
(12) Patent Application Publication
(10) Pub. No.: US 2007/0094700 A1
(43) Pub. Date: Apr. 26, 2007

(54) Game delivery system

(76) Inventor: Jason Wolfe, Stamford, CT (US)

Correspondence Address: MUSKIN & CUSICK LLC, 30 Vine Street, SUITE 6, Lansdale, PA, 19446, US

(21) Appl. No.: 11/337,972

(22) Filed: Jan. 23, 2006

Related U.S. Application Data
(60) Provisional application No. 60/730,347, filed on Oct. 25, 2005.
(60) Provisional application No. 60/730,348, filed on Oct. 25, 2005.
(60) Provisional application No. 60/730,337, filed on Oct. 25, 2005.

(51) Int. Cl. H04N 7/173; G06F 17/00; A63F 13/00; A63F 9/24; G06F 19/00; H04N 7/16

(52) U.S. Cl. 725/133; 725/141; 463/1; 463/40; 463/42

(57) ABSTRACT

A game delivery system wherein games can be delivered to players using a cable television infrastructure. Players can interact with the game via an input device such as a remote control, and the user's set top box can communicate with the cable headend in order to effectuate game play. A player can also win cash or noncash prizes in a tournament with other players as well.

### CROSS REFERENCE TO RELATED APPLICATIONS

This application claims benefit to provisional application No. 60/730,347, filed on Oct. 25, 2005, which is incorporated by reference herein in its entirety. This application claims benefit to provisional application No. 60/730,348, filed on Oct. 25, 2005, which is also incorporated by reference herein in its entirety. This application claims benefit to provisional application No. 60/730,337, filed on Oct. 25, 2005, which is also incorporated by reference herein in its entirety.

### BACKGROUND OF THE INVENTION

1. Field of the Invention

The present invention is directed to a system which can deliver games, including wagering games, to players using their cable television equipment.

2. Description of the Related Art

Gambling games are readily available in casinos. However, players may wish to play games from the convenience of their homes for real money. One option is for players to play gambling games using the Internet. However, this has disadvantages, which include questionable legality, difficulty in registering, making and receiving payments, limited types of wagering experiences available, and may require particular hardware.

What is needed is a method in which players can achieve an entertaining experience using delivery methods such as their standard cable television equipment.

### SUMMARY OF THE INVENTION

It is an aspect of the present invention to provide a system to encourage e-commerce and reward participants.

The above aspects can be obtained by an apparatus that includes (a) a cable headend comprising a processing server to serve the game to an end user; and (b) a content provider to store game content and to serve the game content to the processing server at the cable headend.

The above aspects can also be obtained by a method that includes (a) maintaining game content by a content provider using a content server; (b) serving the game by a cable company to a subscriber's cable television set top box using the game content; and updating the game content by the content provider without direct participation by the cable company.

The above aspects can also be obtained by a method that includes (a) registering a new user to the game using a remote control in communication with a set top box; (b) transmitting registration information for the new user to a content provider database; (c) commencing a tournament among multiple players including the new user, tournament data stored by the content provider database; (d) initiating a process administered by the cable company to implement the game for the new user; (e) requesting game content information, by the process, from the content provider; (f) transmitting the game content information from the content provider to the process; (g) using the game content information to generate game output; (h) serving the game output of the game to the set top box; and (i) modifying, by the content provider, the game content information without intervention by the cable company.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is block diagram illustrating exemplary hardware need to implement an embodiment;

FIG. 2 is a flowchart illustrating an exemplary method of serving a game, according to an embodiment;

FIG. 3 is a flowchart illustrating an exemplary method of registering a new account, according to an embodiment;

FIG. 4 is a flowchart illustrating an exemplary method of retrieving an animation sequence, according to an embodiment;

FIG. 5 is a flowchart illustrating an exemplary method of managing a tournament, according to an embodiment;

FIG. 6 is a data flow diagram illustrating an example of data used to create the game, according to an embodiment;

FIG. 7 is a flowchart illustrating an exemplary method of a content provider changing course conditions, according to an embodiment;

FIG. 8 is a block diagram illustrating aggregation and delivery of multiple outputs, according to an embodiment;

FIG. 9 is a flowchart illustrating an exemplary method of implementing a tournament, according to an embodiment;

FIG. 10 is an exemplary screen shot illustrating one example of a leaderboard, according to an embodiment;

FIG. 11 is an exemplary screen shot illustrating one example of a golf game, according to an embodiment; and

FIG. 12 is an exemplary flowchart illustrating a method of displaying pre-rendered sequences, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present general inventive concept relates to a method, system, and computer readable storage to implement games which can be played by players in different locations. The games can, for example, be delivered using a player's standard cable television reception equipment. In one embodiment, a multi player golf game can be distributed to a plurality of players who can play in a tournament using their standard cable television equipment (e.g. set top box, remote control, television).

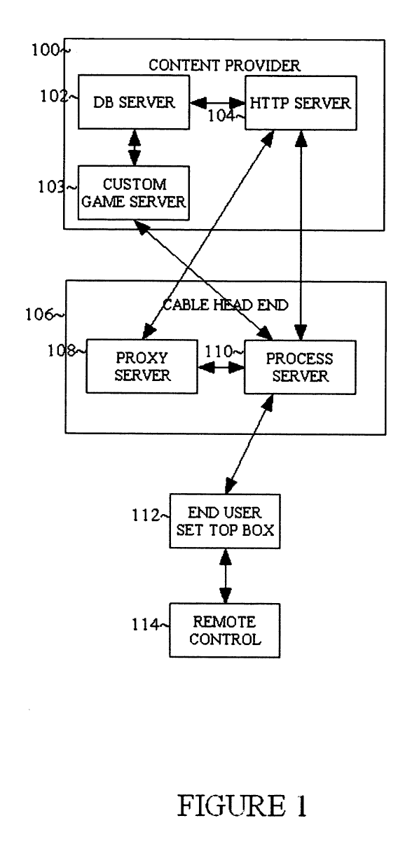

FIG. 1 is block diagram illustrating exemplary hardware need to implement an embodiment.

A content provider 100 can be maintained by a company responsible for content for a game(s). The content provider 100 can be at a location separate from the cable head end 106, or alternatively it can be present at the same location.

A database server 102 can maintain the tables necessary to implement the game. The database server 102 can also store records for each user and their respective scores as well as any other needed game resources. A custom game server 103 can communicate with the DB server 102 and the process server 110 (and also optionally any of the other components illustrated (or not illustrated) in FIG. 1) such as the HTTP server 104, etc. The custom game server 103 directs the game play game play/resources and can be used to retrieve data from the DB server 102. For example, the custom game server 103 can receive move data from the end user (for example a strength and a direction of a shot) and look in the DB server 102 for a respective entry (based on the move data and the current location of the golfer and optionally other data such as weather) and retrieve data from the DB server 102 indicating which animation sequence should be displayed as well as where the ball will end up for the next shot. The custom game server 103 can then pass this and related data to a respective process running on the process server 110 for a particular player (it can also be passed to a web browser running a java client).

An http server 104 can host/serve all of the files, such as content, scripts, graphics, executables, etc. necessary to implement the game. The http server 104 can retrieve data from the database server 102 regarding player information and any needed game information.

The cable head end 106 is used to deliver a cable signal to each subscriber. At the head end 106 is proxy server 108 which can be used to communicate with the content provider 100 and a process server 110. The proxy server 108 can be used to cache the game's executables and graphic data. The process server 110 can be used to run processes which can implement the game and serve video/audio output to an end user set top box 112. The cable head end 106 can be located at a different location than the content provider 100, although in an alternative embodiment, they can be (or any components of each) can be combined at a same location. The process server 110 can host many instances of an operating system such as WINDOWS. Each of these instances can run a copy of a browser such as INTERNET EXPLORER which can run a copy of the JAVA plug-in, which can run a Java binary of the game software. The output of the game software can be encapsulated and sent as an MPEG stream to end users' cable boxes. The users' input (e.g. from the remote control or other input device) can be captured from the respective cable boxes and passed into INTERNET EXPLORER (or other browser being used) which then relays the users' respective input to the JAVA plug-in, which then relays them to the JAVA binary of the game software.

It is noted that the arrangement in FIG. 1 is merely one example of a configuration, and other configurations can be used as well. For example, data can be stored on additional servers, or servers can be combined into one, etc. Any type of data or process described herein can be stores/executed on any component illustrated in FIG. 1 (or not pictured but described herein or known in the art), and any component illustrated in FIG. 1 can communicate with any other component in FIG. 1 (or not pictured but described herein or known in the art). As another example, the DB server 102 and the custom game server 103 can be combined, and/or they can also be combined with the http server 104. Any servers can be located on the same physical computer or different physical computer(s), and can also be located in a same physical location as others or different locations.

A remote control 114 can be used by an end user to interface with the end user set top box 112 and allow the end user to play the game.

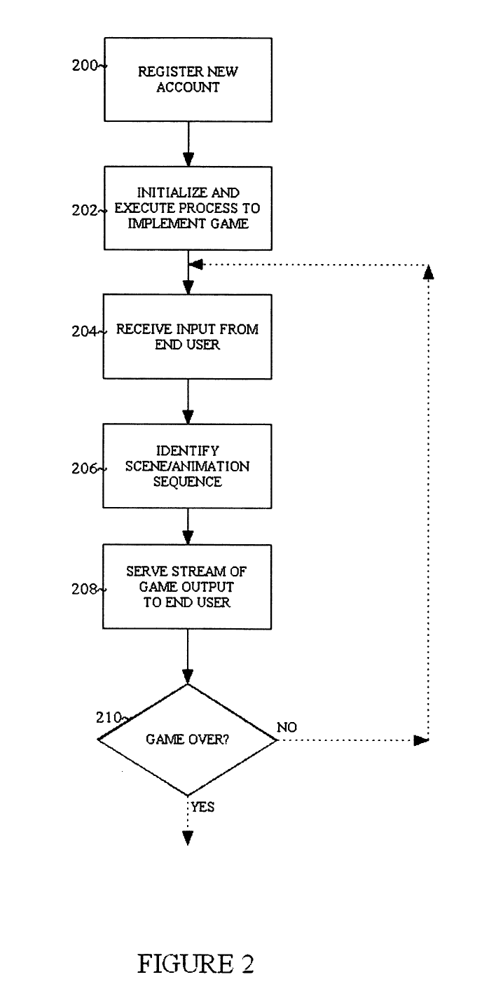

FIG. 2 is a flowchart illustrating an exemplary method of serving a game, according to an embodiment.

The method can begin with operation 200, wherein a player registers a new account. This can be done online or using a remote control interfacing with a set top box which can then communicate with the cable head-end which in turn can set up a user account at a DB server. The account information can be maintained by the content provider although the cable headend would typically need to access account information or derivatives of it in order to serve aspects of the game which need account information. This operation will be discussed below in more detail. Each cable TV box can correspond to an account at a cable company (which typically, although not required to do so, maintains the headend). The game software can also ask each user to sign up a separate username and password so that each user can appear on leaderboards. Thus, players may have two separate accounts, one for the cable company and one for the content provider of the game. Thus, typically the account registered in operation 200, would be separate from an account a respective user/player already has with the cable company.

From operation 200, the method can proceed to operation 202, which initializes and executes a process to implement the game. A server(s) at the cable headend can handle multiple processes. A process can be initialized and executed for each subscriber. Each process would typically need to communicate with both the subscriber and the content provider.

From operation 202, the method can proceed to operation 204, which receives an input from the end user. The input can be inputted using the remote control. Game parameters can be inputted, such as a swing speed, direction, etc. These parameters are then used to affect and progress the game

From operation 204, the method can proceed to operation 206, which identifies a scene/animation sequence. After a player inputs his or her course of action, the player can watch a sequence on his or her television streamed from the cable headend. Frames which are streamed can be served in real time or a sequence can be pregenerated and transmitted to the subscriber's set top box. In the latter case, each sequence can be indexed with a number. A table can be used to map particular conditions to a sequence number. For example, table I below illustrates an example table of mapping animation sequences based on a single parameter (shot strength), although of course additional/other parameters may be used a well.

TABLE I

| Index # | shot strength |
|---|---|
| 1 | 5 |
| 2 | 6 |
| 3 | 7-9 |
| 4 | 10 |

Thus, for example, if the player is playing a golf game and the only parameter is a shot strength, then if the shot strength ends up (either by an exact choice by a player or using some type of real time coordination mechanism such as a “swing meter” as known in the art) as a 10, then by using Table I, animation number 4 can be served to the player's television (or other output device). These can be pregenerated animation sequences which can be served to players. In addition to serving players via a cable delivery system, sequences can be served to cell phones via a cellular network, or home computers via any computer communication network, etc. In an alternative embodiment, animations may not necessarily be pregenerated but can be rendered “on the fly” as needed.

From operation 206, the method can proceed to operation 208, which serves a stream of game output to the end user. This can be done as known in the art, wherein each user's set top box typically has an IP address associated with it which can receive audio/visual signals to display on a television.

From operation 208, the method can proceed to operation 210, which checks If the game is over. If the game is not over, then the method can return to operation 204, which receives additional input from the end user (e.g. an additional golf swing).

If operation 210 determines that the game is over, then the method can end and a result of the game can be tabulated in the DB server.

A player can purchase entry into a game (or tournament) or alternatively can play for free. A plurality of players can all purchase entry into a tournament, and the money can be pooled and divided by the winners (with an optional commission removed by the game providers). Tournament parameters can be data relating the tournament such as costs, prizes, etc., can be changed along with course conditions and other game data by the content provider using methods described below in more detail.

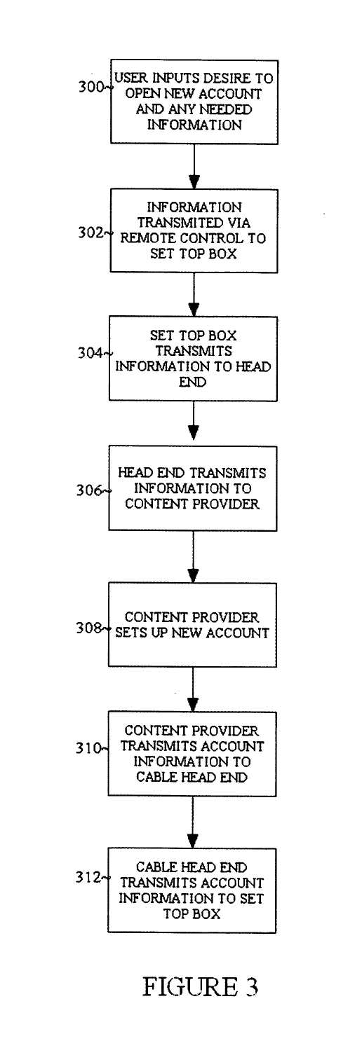

FIG. 3 is a flowchart illustrating an exemplary method of registering a new account, according to an embodiment. This operation is related to operation 200 from FIG. 2.

The method can begin with operation 300, wherein the user inputs a desire to open a new account with any needed information. This can be done using the user's remote control, keyboard, or any other input device.

From operation 300, the method can proceed to operation 302, where information inputted can be transmitted via a remote control to a set top box. This operation is needed if the user is registering via a remote control.

From operation 302, the method can proceed to operation 304, wherein the set top box transmits information to the cable head end. The cable delivery system can accommodate two way transmissions such that each subscriber (or user or player) can receive individual targeted communications and also transmit communications to the headend. Each set top box can have its own IP address in order to uniquely identify communications and facilitate delivery. The process server may host a separate instance of WINDOWS for each connected user.

From operation 304, the method can proceed to operation 306, wherein the head end can transmit information to the content provider. This can be done using any of the servers described herein (or not described but known in the art) using any computer communications network (e.g. the Internet). The head end can transmit information the head end knows about the subscriber (who can be identified by his or her IP address or other method) such as the subscriber's name, address, etc. This can make the registration process easier, as the content provider can automatically receive this information from the cable company without need for the player to re-enter it. This information can also be used to verify that a player is who he says he or she is.

From operation 306, the method can proceed to operation 308, wherein the content provider can set up a new account. The content provider can use a database, such as an SQL database, to maintain the user's accounts. A user account will typically have information such as user name, id number, contact information, game standings, etc. The content provider can request any additional information that the content provider needs (e.g. credit card information, address, etc.)

From operation 308, the method can proceed to operation 310, wherein the content provider can transmit account information to a cable headend. A process running on the cable headend can receive confirmation that a new account has been opened and that the process can continue implementing the game now that a valid account has been associated with it.

From operation 310, the method can proceed to operation 312, wherein the cable head end can transmit account information to the set top box. The information can be audio/visual information to display to the player such as tournament information, the actual game, etc.

During play of the game, certain animation sequences may be needed. These can be provided by the content provider but a local cache of them can be optionally stored by the cable company to improve speed.

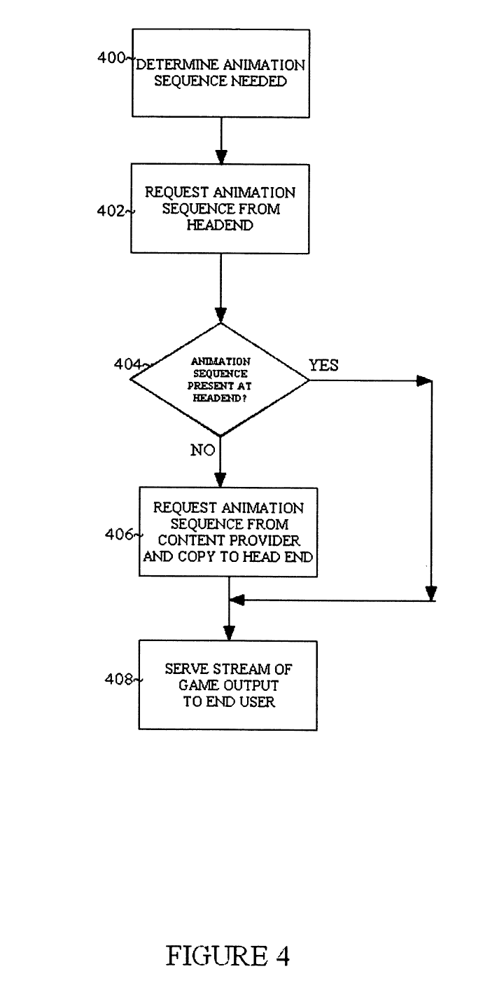

FIG. 4 is a flowchart illustrating an exemplary method of retrieving an animation sequence, according to an embodiment.

The method can start with operation 400, which determines an animation sequence needed. This can typically be done by the process server, although any other component described herein can perform this operation as well. When the user inputs his or her move data, this data can be used to determine a particular animation sequence needed which will be transmitted to the set top box and outputted on the user's output device (e.g. television set). Move data can be data that the user either enters specifically (e.g. move up), or uses his or her remote control (or other input device) to indirectly determine. For example, in a golf game, a user's swing may be determined by an actual time the user presses a button on the remote (in conjunction with a “swing meter” or other output indicator on the television). Data relating to the user's data input (e.g. time button pressed and/or direction of joystick, etc.) can then be transmitted to the process server 110. The process server can receive the move data and determine an animation sequence needed (alternatively any other component can make this determination as well).

For example, if the user presses the remote control at a particular time using a swing mater, as known in the art, and the power of the swing is 10 units and the direction is 20 degrees, then a table can be used to identify a particular animation sequence needed. For example, a table can be used to look up a particular sequence, such as if a strength is 10 and the direction is 20 degrees, then animation #12345 can be used.

From operation 400, the method can proceed to operation 402, which requests the animation sequence from the headend. Typically this can be done by the process server which will request the animation sequence from the respective server at the headend, such as the proxy server 108, although the animation sequence can be stored on and requested from any other server as well.

From operation 402, the method can proceed to operation 404, which checks if the animation sequence is present at the headend. The headend can store animation sequences, but may not have all the ones that exist. If the needed animation sequence is not present at the headend, then it can be retrieved from the content provider.

If the check in operation 404 determines that the animation sequence is not present at the headend, then the method can proceed to operation 408, which requests animation sequence from content provider and copies it to the head end.

From operation 406 or 408, the method can then proceed to operation 410, which serves the stream of the game output to the end user.

Games delivered using delivery systems described herein can also implement tournaments. A tournaments is a game where more than one player can compete with each other. Winner(s) of the tournament can win prizes, including cash prizes. When players compete with each other, a tournament can be set up with an appropriate group of players. An appropriate group of players may comprise a group of players with compatible skill levels, compatible entry prices, etc.

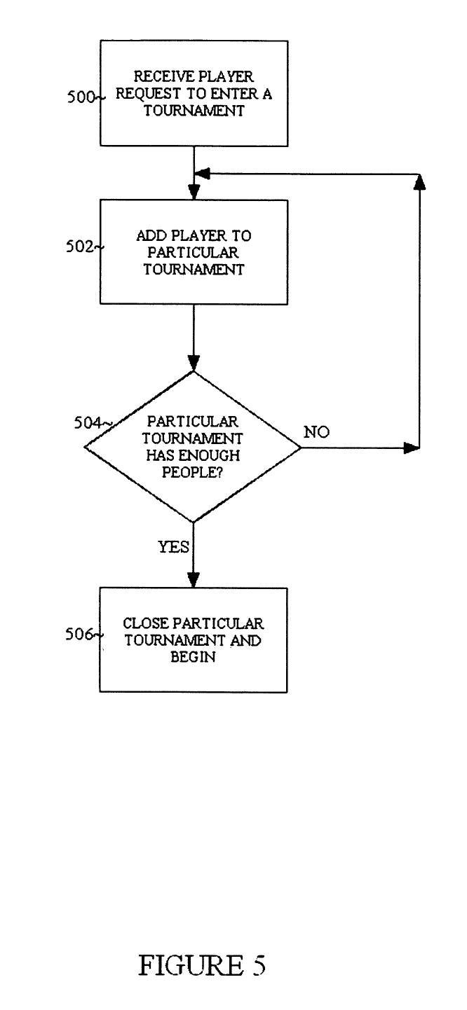

FIG. 5 is a flowchart illustrating an exemplary method of managing a tournament, according to an embodiment.

The method can start with operation 500, which receives a player request to enter a tournament. This can be done using the player's input device, such as his or her remote control.

From operation 500, the method can proceed to operation 502, wherein the player is added to a particular tournament. The particular tournament can be chosen by the player or assigned by the system (either randomly or according to criteria such as skill level, etc.)

From operation 502, the method can proceed to operation 504, which determines if the tournament is ready to begin. This can be based on one or more criterion, such as whether the tournament has enough people. If the tournament is not ready to begin, then the method can return to operation 502 which can add more players (when additional players are actually available to join).

If the determination in operation 504 determines that the tournament is ready to begin, then the method can proceed to operation 506, wherein the particular tournament is closed and the tournament can begin. The database server 102 operated by the content provider 100 may then initiate the actual commencement of the tournament by transmitting to the cable head end which can also include the process server 110 to being the tournament by executing processes for each of the participants in the particular tournament.

Embodiments of delivery systems described herein can combine data from multiple sources. This can facilitate distributed maintenance and support for the system by allowing different parties to easily control portions of the system. For example, the party controlling the content can control aspects of the game (such as courses, course conditions, tournament parameters (e.g. cost to play, etc.) and other data) without need to involve the cable company.

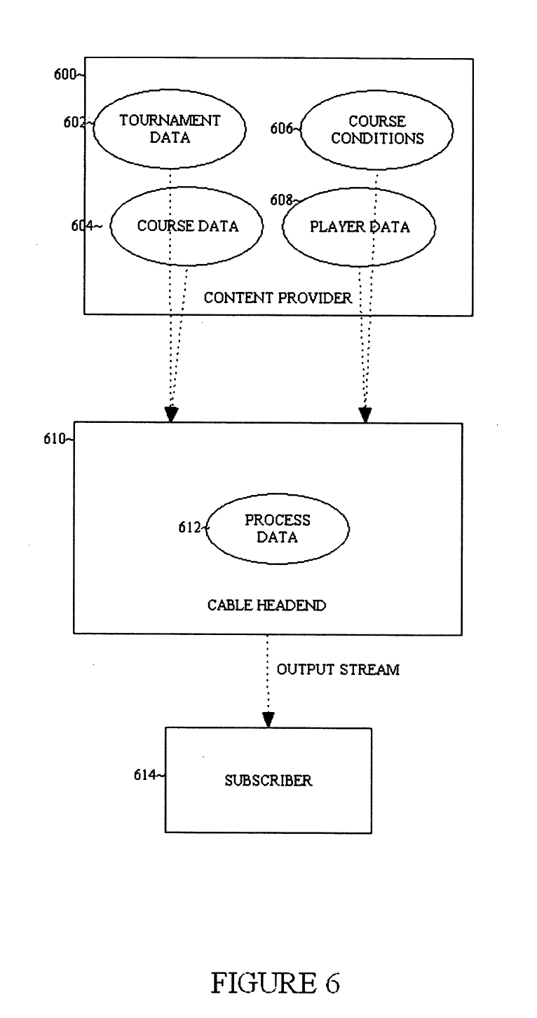

FIG. 6 is a flow diagram illustrating an example of data used to create the game, according to an embodiment.

A content provider 600 can store game specific data that is needed to operate any game(s) to be served to end users. Such data can include tournament data 602, which can comprises data regarding current (and optionally past and/or future) tournaments including their participants, scores, etc. This data can be used to display tournament statuses to players. Data stored at the content provider 600 can also be course data, which can be data related to any playing fields/maps used for games. For example, if the game served is a golf game, then course data can be map data for the golf course(s) used. Data stored at the content provider 600 can also be course conditions 606. Course conditions 606 can be variable data which can affect the affects of physical objects in the game, for example wind speed in a golf game, snow or rain for a racing game, etc. Data stored at the content provider 600 can also be player data 608. Player data 608 can be data relating to player accounts and/or their points accrued, standings, etc. The content provider can also store any other data needed to implement a game as known in the art. All of the data at the content provider can be requested by and transmitted to any other component as described herein (or not described herein but known in the art).

The cable headend 610 is used to transmit audio/visual to the end user which can use the user's cable connection. Process data 612 can be stored at the cable headend and can comprise any data used by a current process which is implementing an instance of the game. This data can, for example, include, random numbers generated, data used to receive inputs from the player (e.g. results from a “swing meter”) and any other data known in the art to be needed by a process which is implementing a game.

A subscriber 614 can receive an output stream of the subscriber's particular process via his cable connection. The subscriber can also communicate with his or her process via an input/output device such as a remote control.

A content provider support center (not pictured in FIG. 6) can access/modify data at the content provider. This support center can be used to receive inquiries by players regarding their accounts (such as questions, charges, etc.) and can be operated by the content provider. This support can be provided independently of any customer service provided by the cable company.

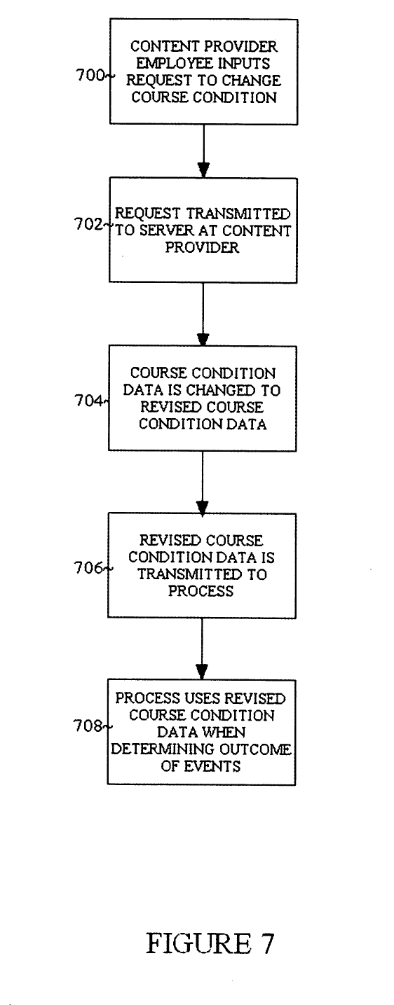

FIG. 7 is a flowchart illustrating an exemplary method of a content provider changing course conditions, according to an embodiment.

The method can start with operation 700, wherein a content provider employee inputs a request to change a course condition to a revised course condition. The request can be entered into a computer connected to the content provider via any computer communications network.

From operation 700, the method can proceed to operation 702, wherein the request from operation 700 is transmitted to the content provider and typically the database therein.

From operation 702, the method can proceed to operation 704, wherein the course condition data is changed to the revised course condition data in the database.

From operation 704, the method can proceed to operation 706, wherein the revised course condition data is transmitted to any processes that use the course condition data.

From operation 706, the method can proceed to operation 708, wherein each process uses the revised course condition data when determining an outcome of events. For example, a direction a ball travels may be affected according to wind speed using classical physics.

Thus, it is noted that the content provider can change information related to the game such as course conditions independently of the cable company. In other words, these changes can be made without obtaining permission or assistance from anyone at the cable company which is responsible for maintaining the headend. Other information in addition to course conditions relating to the game can also be changed using methods described herein, such as tournament parameters, etc.

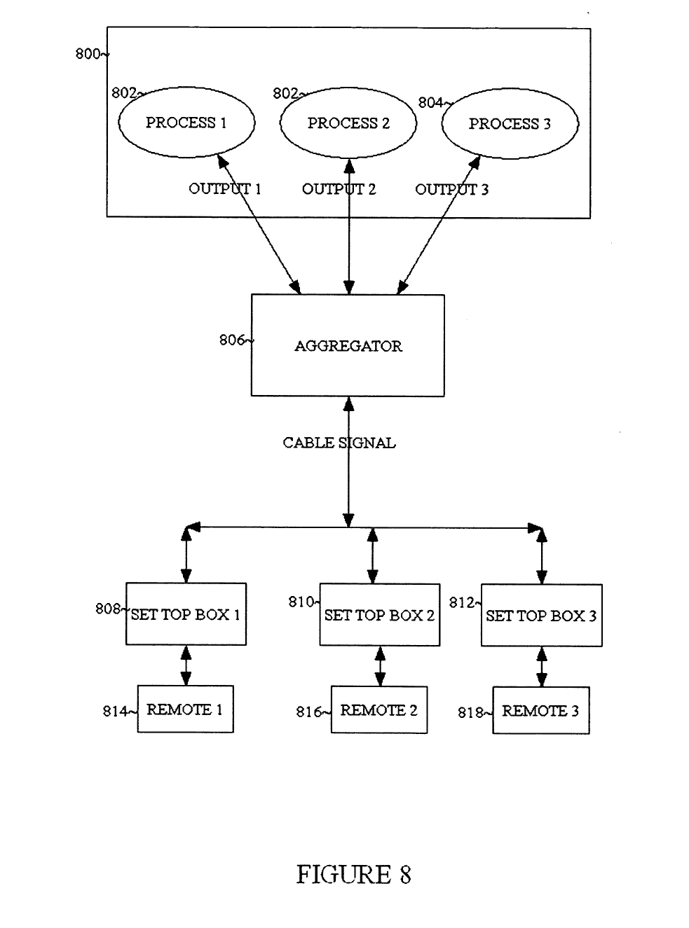

FIG. 8 is a block diagram illustrating aggregation and delivery of multiple outputs, according to an embodiment.

The server 800 can be process server 110 such as described herein. Process 1 802, process 2 804, and process 3 806, can be executing on the server 800 simultaneously. Each process can generate their own unique output, output 1, output 2, and output 3.

Output 1, output 2, and output 3 can all be received by an aggregator 806, which can receive multiple inputs and combine them into a cable signal. Output 1, output 2, output 3 can be in any form, such as MPG, etc.

The cable signal can then be transmitted to each respective user, such as set top box 1 808, set top box 2 810, and set top box 3 812. Set top box 1 should receive output 1, set top box 2 should receive output 2, and set top box 3 should receive output 3. Each of the set top boxes can have a unique IP address (or some other identifier) so that they can communicate individually with other components of the system. Remote 1 814, remote 2 816, and remote 3 818 are remote controls that can communicate with set top box 1 808, set top box 2 810, and set top box 3 812, respectively. Note that input from the remotes can be transmitted to their respective process through the network as well. For transmissions from the set top boxes to the respective processes, use of a component to isolate each particular signal and route it to the proper process may be needed (not pictured).

For more information on how operations described herein (such as transmitting graphics and other information from a computer to an individual user's television set using a cable network), see U.S. Patent Publication 2004/0181818, entitled, “Method for Enabling a Television User to Control Operation of Application Programs on a Programmable Television Controller,” which is incorporated by reference herein in its entirety. See also U.S. Pat. Nos. 6,286,140, 5,801,747, 6,449,632, 6,457,010, and 5,497,185, which are all also incorporated by reference in their entireties.

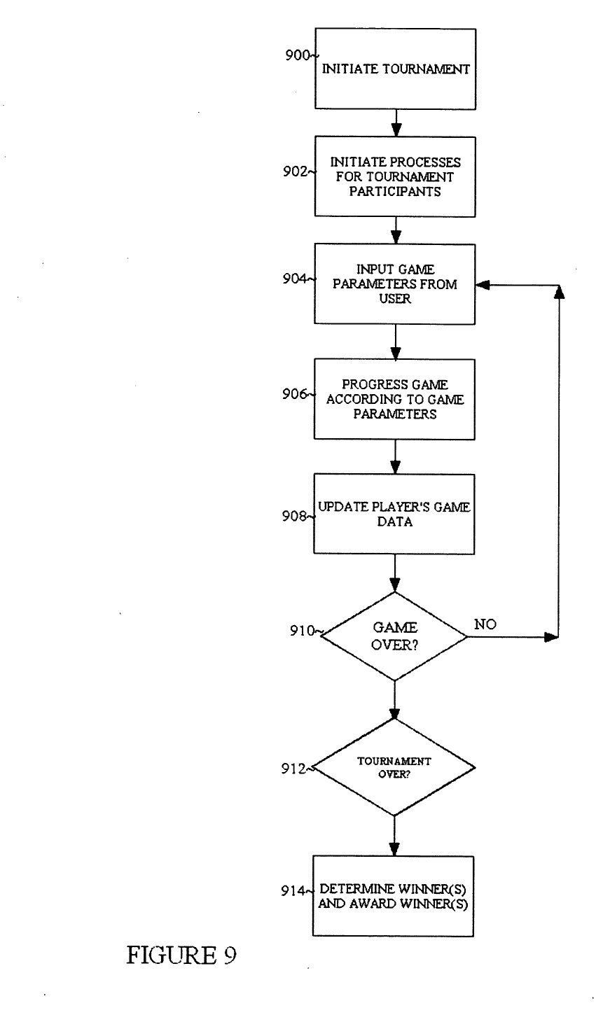

FIG. 9 is an exemplary flowchart of a method to implement a tournament using a cable delivery system, according to an embodiment.

The method can start with operation 900, which initiates a tournament. See FIG. 5 and the respective description for more details on this operation.

From operation 900, the method can proceed to operation 902, which initiates processes for tournament participants. Each participant can have their own process executing on a process server (such as process sever 110). Alternatively, some set top boxes may have the capability to execute processes on the set top box itself. Thus, in an alternate embodiment, some or all of the required processes may be executed on the user's set top box itself.

From operation 902, the method can proceed to operation 904, which inputs game parameters from user. For example, the user can use his or her remote control along with a “swing meter” to time a swing as best as possible by the user. The user's entry is transmitted to his or her respective process, which can process the user input to determine the exact value thereof. For example, if the player swings after 2.35 seconds after a swing meter is initiated, this delay can be converted into an actual shot strength. This can be done using a table, linear relationship, or any other known method.

From operation 904, the method can proceed to operation 906, which progresses the game according to the game parameters determined in operation 904. For example, knowing the shot strength, the shot trajectory can now be calculated. What also can optionally be incorporated into play are current course conditions. These can be requested by the user's process from the tournament database and movement of physical objects may be affected by course conditions. For example, if a golf ball may travel in a different trajectory depending on wind speed. Once the outputs of the current segment of the game are determined, they can be outputted to the user, as described herein.

From operation 906, the method can proceed to operation 908, which updates the player's game data. For example, the results of the prior segment of the game can be transmitted to a database (such as the database server 102) operated by the content provider. Thus, if a player scores a hole in one on the last hole, this information can be reflected in the database. Other players in the tournament may be able to view the tournament data to see how they stand in relationship to other players. The process itself for each respective player can update this information in the database by using any communications infrastructure implemented.

From operation 908, the method can proceed to operation 910, which determines if the game is over. If the game is not over, then the method can return to operation 904, wherein the player is prompted to yet enter further game parameters. For example, each time the player needs to take a swing in a golf game, operation 904 can input from the player the player's swing data.

If the determination in operation 910 determines that the game is over, then the method can proceed to operation 912, which determines if the tournament is over. A tournament can be considered over if there are no more live players (e.g. every player has finished or forfeited due to lack of play or other reason). If a tournament is not over, then other players may still be executing operations 904 to 910 and so the method may proceed to wait (not pictured) until the tournament is over.

When the tournament is over, the method can proceed to operation 914, which can determine the winners and award the winners. If the tournament is a golf game, then a winner (or winners) may be the player with the lowest score (or scores). Winners can receive their money via a check or any other payment method.

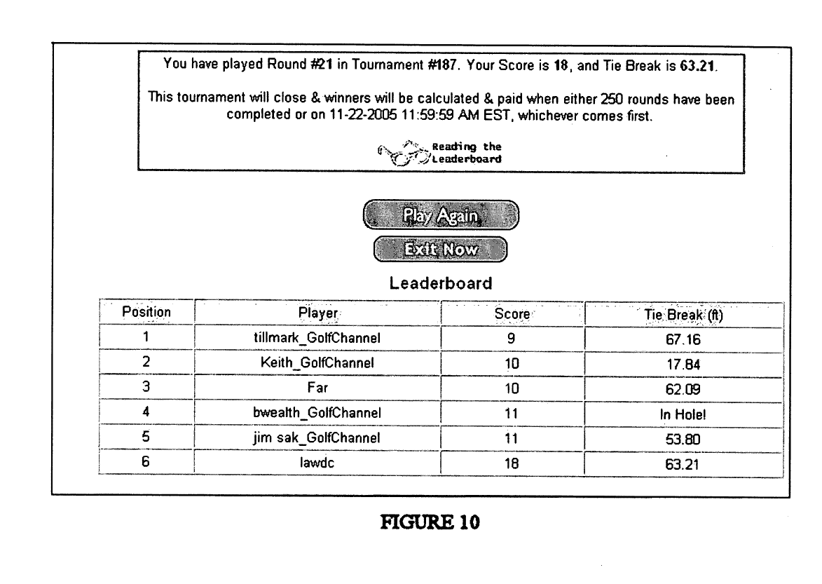

FIG. 10 is an exemplary screen shot illustrating one example of a leaderboard, according to an embodiment.

A leaderboard displays tournament data (any data related to the tournament and its participants). The leaderboard displays the tournament participants, their positions, and respective scores. A player can view the leaderboard to see how he or she stands. Data for the leaderboard can be stored by the content provider in a database (such as database server 102).

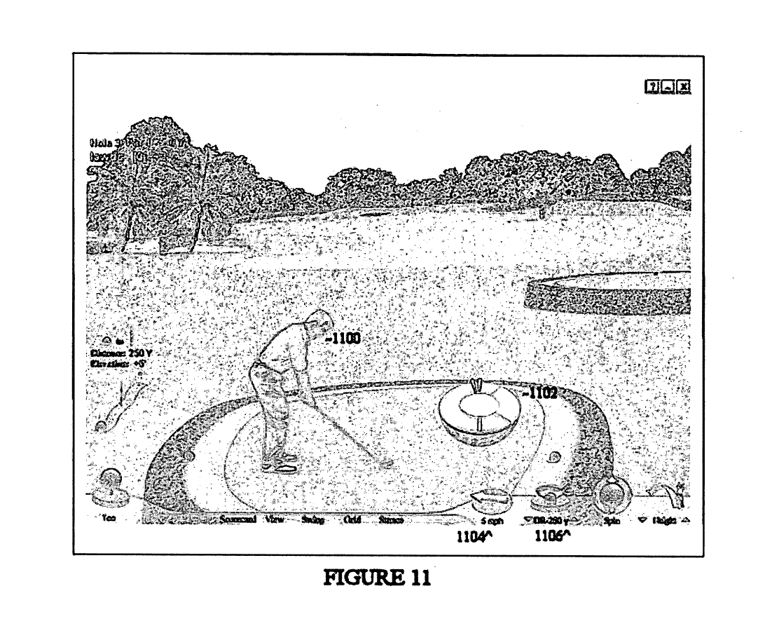

FIG. 11 is an exemplary screen shot illustrating one example of a golf game, according to an embodiment.

A visual animated golf game can be served/streamed to each player. A golfer icon 1100 is used to actually “swing at the ball.” A swing meter 1102 can be used in order to capture the player's swing as known in the art. For example, a user can click the swing meter 1102 and an indicator begins to move clockwise around the circular swing meter 1102. The player can click again to stop the swing meter from moving which can determine the swings power. The swing meter can then move counter clockwise, upon which the player can then click again which determines the direction of the swing. While the player can use his or her remote control to activate the swing meter, the process running the game can receive the timings of the player's presses and compute actual game parameters (e.g. strength, direction, etc.) from the timings.

A wind direction indicator 1104 indicates a direction and strength of wind. This is a course condition which can be stored on the database server administered by the content provider. The wind direction can affect the trajectory of the ball when hit. A club indicator 1106 indicates which particular golf club is selected.

As discussed herein, animation sequences can be pre-rendered in order to save on processing time. This can be beneficial in that processing power on set top boxes and/or cable head-ends may be limited.

Table II illustrates an exemplary shot table comprising data which can be used to identify pregenerated scenes.

TABLE II

| Scene | | | ending | animation |
|---|---|---|---|---|
| ID | strength | direction | coordinates | file |
| 0001 | 10 | 5 | 40, 60 | flight23 |
| 0001 | 5 | 8 | 55, 24 | flight90 |
| 0002 | 5 | 8 | 55, 29 | flight91 |

An x-y coordinate in the “world” corresponds to a scene ID. A table can be used in map x-y coordinates to scene IDs. For example, if scene ID 0001 corresponds to an x,y coordinate of 100,100, and the player takes a shot with strength 10 and direction 5, then the coordinate the ball will land on will be 55,24 (note three dimensional coordinates can be used as well). The file which contains animation data to display a moving ball is “flight90.” The ball trajectory is animated while the scene (the objects such as grass, trees, etc.) can remain the same and is not typically part of the file which contains the animation data.

Thus, each location on the grid (the “world”) has a plurality of pre-rendered animations for the ball. The respective pre-rendered animation is chosen based on the move data for that location. It is noted that different locations may have different trajectories even for identical move data because of obstacles on the course (e.g. a tree may be in front of the player in one location and thus the ball may bounce off that tree in that one location but may not in a different location without the tree, even though the move data (strength, direction, etc.) will be the same). Things such as the angle of the ground can be taken into account when pre-rendering each shot. Factors such as wind speed can be accounted for by having the wind speed affect results of the swing meter (e.g. move data) before things like direction and/or strength are passed to the respective process running on the process server. For example, if a wind speed of 5 MPH north would cause the ball to land at a particular coordinate, then an adjust of the direction and strength can be done automatically to make the ball land at the coordinate. Thus, new pre-renderings for different wind speeds are not necessary.

When the player is at a new location, a pre-rendered scene (e.g. the course, trees, etc) can also be retrieved and displayed based on the player's coordinates. From a table such as that in Table II, the ball's ending coordinates is known so the new location can be determined and a pre-rendered scene can be mapped to those coordinates, served to the player, and displayed. Once the move data is know, the ball is animated according to the respective animation file which contains the coordinate data for the balls trajectory which is displayed over the pre-rendered scene which can remain static. Alternatively, a pregenerated animation sequence can be displayed on its own without a pre-rendered static scene.

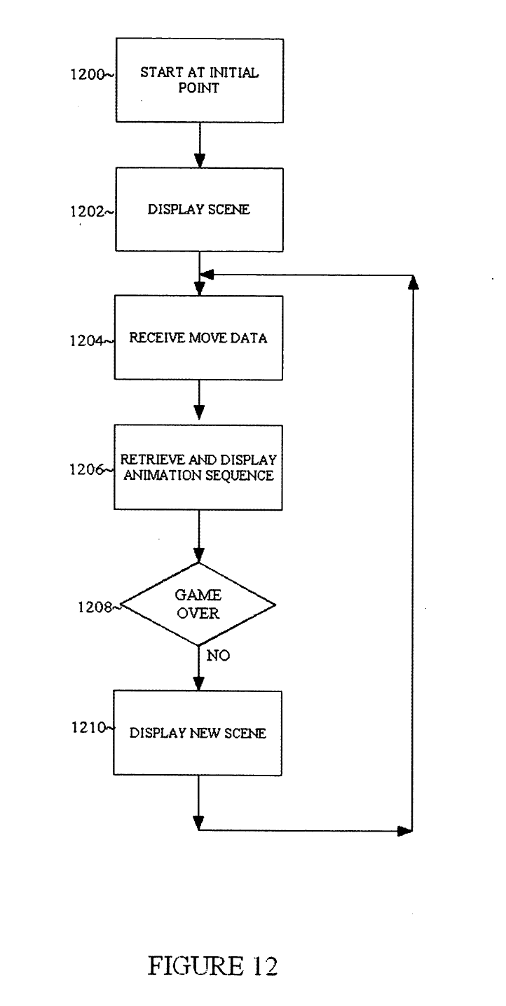

FIG. 12 is an exemplary flowchart illustrating a method of displaying pre-rendered sequences, according to an embodiment.

The method can begin with operation 1200, which starts at an initial point. For example, if the game is beginning a new hole, then the coordinate for the tee for each hole is predetermined.

From operation 1200, the method can proceed to operation 1202, which displays the respective scene for the current coordinate. A table can be used to store x,y (and possible z) coordinates and a respective image file which can contain a pre-rendered scene for that balls location. Typically, the player will always face the pin, although this is not required. Additional files can also be pre-generated and available for different directions the player wishes to face.

From operation 1202, the method can proceed to operation 1204, which receives move data from the player. This can be accomplished as described herein (and known in the art), wherein a player uses a controller to determine his or her strength and direction of a shot.

From operation 1204, the method can proceed to operation 1206, which retrieves and displays an animation sequence. A respective animation sequence can be retrieved as described herein, using the player's current coordinates and the move data to determine a final location of the ball and a file which stores animation data for the motion of the ball. The file can be, for example, a series of x,y coordinates (screen coordinates or world coordinates) wherein the ball is animated (displayed in a time sequence at each of the coordinates in sequence) through those coordinates (displayed on another image such as a view of the golf course). The file can be served to the player's set top box which can then display the animation or the animation can be rendered at the cable head-end wherein the final output is served to the player. Alternatively, instead of storing a sequence of x-y coordinates, the motion of the ball can be determined mathematically using classical physics from the move data (and other data such as the weather conditions), and the ball can be displayed superimposed over the pre-rendered scene in time sequence using coordinates for the ball determined mathematically.

Thus an animation sequence which is displayed to the end user can comprise a static pre-rendered scene (e.g. a view of the golf course) and a moving ball which moves on the pre-rendered scene. The pre-rendered scene and the moving ball can come from separate files and are combined by the system displaying the ball on predetermined coordinates over the pre-rendered scene, but the fact that these aspects come from separate files is transparent to the end user.

Note an advantage of the embodiments described herein is reduced processor power is required. To play an off the shelf game on a home computer, a processor typically needs to be dedicated to that game. When using a cable system to display a game, processing power is limited (either on the set top box or at the cable headend (e.g. the process server). Thus, scenes can be pregenerated and animation coordinates can be predetermined and stored in a file for later playback (moving the ball over those coordinates superimposed over a pre-rendered scene).

From operation 1206, the method can proceed to operation 1208, which determines if the game is over. If the player has played a predetermined number of holes (e.g. 9 or 18) and the last shot resulted in the ball going into the cup, then the game can be over and the game can end (not pictured).

If the game is not over, then the method can proceed to operation 1210 which displays a new scene. If the last shot was not in the cup, then the new scene is based on the coordinates wherein the last shot results in (using for example a table such as Table II). A table can map coordinates to a prerendered image (e.g. a view of the course from that location). If the last shot resulted in the ball going into the hole, then the new coordinates can be predetermined to be on the tee for the next hole. The method can then return to operation 1204, which receives move data for the next shot.

Table III below illustrates one example of sequential communications implemented by various components in the system in order to deliver an interactive game using a cable delivery system.

TABLE III
Remote control -> set top box An “enter” keypress is sent
to the set top box to select the link to Lucky Golfer's game.
set top box -> process server The Cable box propagates the
“enter” to the instance of Internet Explorer running on the process
server at the headend.
process server -> proxy server The process server requests
the game executable from the proxy server. If the game executable
exists on the proxy server, it forwards it. Otherwise it requests it
from the HTTP server.
Proxy server -> HTTP server If the proxy server doesn't
have a local copy of the game executable, it requests one from the HTTP
server.
HTTP server -> proxy server If the proxy server has
requested a copy of the game executable, the HTTP server provides it.
The proxy server stores the copy from this point on.
proxy server -> process server The proxy server passes on a
copy of the game executable to the process server. The process server
runs the executable.
process server -> custom game server The game connects to the
custom game server and sends a ‘hello’ packet.
custom game server-> process server The custom game server tells
the process server what scene to start the game.
process server -> set top box The process server sends an
MPEG stream to the end user's set top box which is then displayed on
the TV. This stream shows the running game executable.
remote control -> set top box The end user uses the remote
control to manipulate the game UI to take a shot.
set top box -> process server The set top box propagates
the user's input to the game executable running on the process server.
process server -> custom game server The executable running on
the process server converts the user's “clicks” (manipulation of the
swing meter) into the strength and direction for the shot. These are
then passed on to the custom game server.
custom game server-> DB server The custom game server looks
up the shot ID in the database which corresponds to the proper scene
ID, strength, and direction for the current shot.
DB server -> custom game server The database returns the
proper shot ID.
custom game server-> DB server The custom game server looks up the
next scene ID which corresponds to the landing point of the current
shot ID.
DB server -> custom game server The DB server returns the
indicated scene ID.
custom game server-> process server The custom game server passes
on the IDs of the shot and next scene to display to the game executable
running on the process server.
process server -> proxy server The game executable running
on the process server requests the ball flight file for the
corresponding shot_id from the proxy server. If this file is not
present on the proxy server, it is requested from the HTTP server.
proxy server -> HTTP server The proxy server requests a
missing ball flight file from the HTTP server.
HTTP server -> proxy server The HTTP server passes on a
requested ball flight file to the proxy server, which then stores it
for future use.
proxy server -> process server The proxy server provides the
requested shot file to the game executable running on the process
server.
process server -> set top box The game executable running
on the process server animates the shot and sends it to the user's TV
via and MPEG stream.
process server -> proxy server The game executable requests
the image for the next scene ID from the proxy server.
proxy server -> HTTP server If the requested scene image
is not present on the proxy server, the proxy server requests it from
the HTTP server.
HTTP server -> proxy server The HTTP server passes on the
scene image to the proxy server if it has been requested. The proxy
stores a copy of the scene image in anticipation of future requests.
proxy server -> process server The proxy server hands the
requested scene image over to the game executable running on the
process server.
process server -> Cable Box The game executable running
on the process server displays the next scene, sending an MPEG stream
of the result to the end user's cable box (and thus to his or her TV).

After the communications occur in Table III, the player then has the opportunity to manipulate the swing meter again (using the remote control) to make another shot. Of course the operations in Table III are merely exemplary, and other data transfer sequences can be used.

It is noted while a golf game is portrayed herein, other games can be used with all of the embodiments herein. For example, bowling, racing, darts, etc.

The embodiments described herein are also not limited to a cable delivery system, but can be used to deliver game content to other platforms as well. For example, games can be delivered using a cellular network, the Internet, a wifi network, a satellite network, etc.

It is further noted that any of the embodiments described herein can be combined with any others and can also be combined with any other methods/apparatus known in the art. Any apparatus or method described herein may also be optional. Any data described herein (or not described herein but known in the art) can be stored at any location anywhere on the system.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. An apparatus to implement a game, the apparatus comprising:
a cable headend comprising a processing server to serve the game to an end user; and
a content provider to store game content and to serve the game content to the processing server at the cable headend.

2. An apparatus as recited in claim 1, wherein the game content is maintained by a developer of the game.

3. An apparatus as recited in claim 2, wherein the developer can update the game served to the end user using the content server

4. An apparatus as recited in claim 1, wherein the cable headend further comprises:
a proxy server to receive game data from the content provider and server the game data to the processing server.

5. An apparatus as recited in claim 1, further comprising:
an aggregator to receive outputs from multiple processes on the processing server and to aggregate the multiple outputs into a single cable single.

6. An apparatus as recited in claim 5, further comprising:
a tournament database to store multiple players participating in a tournament and to serve data relating to the multiple players to the multiple processes on the processing server to display on each player's output device.

7. An apparatus as recited in claim 1, further comprising an animation database at the cable headend accessed by the processing server to store animation sequences, and if a needed animation sequence needed by a particular process running on the processing server is not present on the animation database, then the needed animation sequence is retrieved from a content provider animation database and subsequently stored on the animation database at the cable headend.

8. An apparatus as recited in claim 1, further comprising a support center maintained by the content provider to access data stored by the content provider and answer player questions independent of a company administering the cable headend.

9. An apparatus recited in claim 1, wherein the content provider comprises a database to store pre-rendered scenes and animation files containing ball trajectories, and the processing server at the cable headend serves a respective pre-rendered scene to the end user and an animated ball using a respective animation file superimposed over the respective pre-rendered scene.

10. A method to serve a game, the method comprising:
maintaining game content by a content provider using a content server;
serving the game by a cable company to a subscriber's cable television set top box using the game content; and
updating the game content by the content provider without direct participation by the cable company.

11. A method as recited in claim 10, wherein the content provider manages tournament data, the tournament data being comprised in the game content which is used by the cable company when serving the game.

12. A method as recited in claim 10, wherein the game content comprises course conditions which the content provider can change.

13. A method as recited in claim 10, wherein support for the game is provided by the content provider independently of the cable company.

14. A method as recited in claim 10, wherein a process implementing the game requests game conditions from the content server, the game conditions capable of being changed by the content provider without direct participation by the cable company.

15. A method as recited in claim 10, wherein a process implementing the game requests tournament data standing data from a tournament database to display to an end user.

16. A method as recited in claim 10, further comprising aggregating outputs from multiple processes each implementing a respective player's instance of the game into an aggregated cable signal which is distributed to players.

17. A method as recited in claim 10, further comprising serving simultaneous streams of game output to each of multiple players using a single cable signal.

18. A method to serve a game, the method comprising:
storing a plurality of scenes;
storing a plurality of animation sequences;
inputting move data from a player;
determining a particular scene from the plurality of scenes using the move data;
determining a particular animation sequence from the plurality of animation sequences using the move data; and
serving, using a cable network, an animated sequence to an end user comprising the particular scene with the animation sequence on top of the animated sequence.

19. A method as recited in claim 18, wherein the animation sequences are pregenerated.

20. A method to serve a game via a cable company administering a cable delivery system, the method comprising:
registering a new user to the game using a remote control in communication with a set top box;
transmitting registration information for the new user to a content provider database;
commencing a tournament among multiple players including the new user, tournament data stored by the content provider database;
initiating a process administered by the cable company to implement the game for the new user;
requesting game content information, by the process, from the content provider;
transmitting the game content information from the content provider to the process;
using the game content information to generate game output;
serving the game output of the game to the set top box; and
modifying, by the content provider, the game content information without intervention by the cable company.
